(19) United States
(12) Patent Application Publication
(10) Pub. No.: US 2011/0120124 A1
(43) Pub. Date: May 26, 2011

(54) EXHAUST GAS TURBOCHARGER

(76) Inventors: Klaus Czerwinski, Heimsheim (DE); Martin Schlegl, Rudersberg (DE)

(21) Appl. No.: 12/952,602

(22) Filed: Nov. 23, 2010

(30) Foreign Application Priority Data
Nov. 24, 2009 (DE) 102009054403.8

(51) Int. Cl. F02C 6/12

(52) U.S. Cl. 60/605.1

(57) ABSTRACT

The present invention relates to an exhaust gas turbocharger having a turbine wheel that is rotatably mounted about an axis of rotation and a turbine housing. The turbine wheel expands a combustion engine exhaust gas while the turbine housing includes a high-pressure region and a low-pressure region. Additionally, the turbine wheel is arranged between the high-pressure region and the low-pressure region, and wherein the low-pressure region has an inner shell conducting the exhaust gas and an outer shell, which is arranged for forming an air gap insulation.

The present invention relates to an exhaust gas turbocharger for a combustion engine, more preferably of a road vehicle with the features of the preamble of claim 1.

From WO 2005/042927 A1 an exhaust gas turbocharger is known, which comprises a turbine wheel for expanding exhaust gas of the combustion engine, which is rotatably mounted about an axis of rotation. Furthermore, the exhaust gas turbocharger comprises a turbine housing in which the turbine wheel is arranged between a high-pressure region of the turbine housing and a low-pressure region of the turbine housing.

With known turbochargers the turbine housing comprises a main part in which the turbine wheel is arranged and to which an exhaust pipe forming the low-pressure region and a volute forming the high-pressure region are attached.

Further exhaust gas turbochargers where a volute is attached to a main housing are known from US 2002/0085932 A1 and from US 2006/0133931 A1.

The present invention deals with the problem of stating an improved embodiment for an exhaust gas turbocharger of the type mentioned at the outset, which embodiment is more preferably characterized by improved heat resistance and/or reduced heat radiation into the surroundings of the turbocharger.

According to the invention, this problem is solved through the subject of the independent claim. Advantageous embodiments are the subject of the dependent claims.

The invention is based on the general idea of equipping the low-pressure region of the turbine housing with an air gap insulation. To this end, the low-pressure region is equipped with an inner shell conducting the exhaust gas and an outer shell enveloping the inner shell, which are arranged relative to each other such that between the shells a gap is created which makes the desired insulation effect possible. Through the air gap insulation in the low-pressure region the heat radiation into the surroundings of the turbocharger in this low-pressure region can be significantly reduced. At the same time, the thermal load of the outer shell can be reduced which can be advantageous depending on the configuration of the outer shell.

Particularly advantageous is an embodiment wherein the turbine housing comprises an outlet flange for connecting the exhaust gas turbocharger to an exhaust system of the combustion engine, which with regard to the inner shell and the outer shell is a separate component. The inner shell and the outer shell can now be materially connected to this outlet flange, which simplifies the realisation of the air gap insulation. Particularly advantageous here is a configuration wherein the inner shell and the outer shell are also materially interconnected at the connecting flange. More preferably, a single material connection, more preferably a welded connection, can thus be sufficient to fasten both the inner shell as well as the outer shell to each other and to the outlet flange. This design additionally reduces thermally-related stresses in the region of the material connection, particularly if different materials are used for the outlet flange and the shells, which particularly differ from each other through different thermal expansion coefficients.

According to another advantageous embodiment, guide vanes can be arranged in the high-pressure region of the turbine housing which guide vanes are arranged between two opposite walls conducting the exhaust gas. The inner shell can now extend as far as to these guide vanes and in the process form walls conducting the exhaust gas. Because of this, the inner shell is given an additional function which simplifies the construction of the turbine housing.

According to another advantageous embodiment the turbine housing can have a volute in the high-pressure region. This volute preferably forms a separate component with respect to the inner shell, wherein the inner shell is materially connected to the volute. In other words, the inner shell with this embodiment extends as far as to the volute. According to a particularly advantageous embodiment the outer shell can also be materially connected to the volute. This can be more preferably effected in such a manner that the outer shell is materially connected to the inner shell and to the volute at the same point. Alternatively, integrally moulding the outer shell on the volute can also be provided. In other words, the volute with a portion forming the outer shell extends as far as into the low-pressure region of the turbine housing.

According to another advantageous embodiment it can be provided that the inner shell extends as far as to an inlet of the turbine wheel and defines a turbine wheel contour gap which extends between the turbine wheel and the inner shell from the inlet of the turbine wheel to the outlet of the turbine wheel. In addition or alternatively it can be provided that the inner shell extends as far as to an inlet of guide vanes arranged upstream of the turbine wheel and defines a guide vane contour gap which extends between the guide vanes and the inner shell from the inlet of the guide vanes to the outlet of the guide vanes. Through these measures the inner shell is given additional functions which simplify the construction of the turbine housing.

Particularly advantageous here are further developments wherein the inner shell and the turbine wheel or the inner shell, the turbine wheel and the guide vanes are produced of materials having similar or same heat expansion coefficients. Similar heat expansion coefficients should be present if the individual heat expansion coefficients differ by a maximum of 10% from each other. Same heat expansion coefficients should be present if the individual heat expansion coefficients differ by a maximum of 1% from each other. The material selection for the inner shell and the turbine wheel and if applicable for the guide vanes proposed here results in that in the region in which the inner shell extends the respective contour gap remains comparatively constant even with varying temperatures, since the components defining the respective gap expand in the same manner.

According to a particularly advantageous embodiment it can be provided that the inner shell extends as far as to an inlet of the turbine wheel or as far as to an inlet of guide vanes arranged upstream of the turbine wheel, wherein the inner shell downstream of the turbine wheel has a smaller wall thickness than in the region of the turbine wheel or than in the region of the turbine wheel and the guide vanes. Because of this it is particularly possible to select a greater wall thickness in the region of higher loads of the inner shell, namely in the region of the guide vanes or in the region of the turbine wheel than in regions exposed to lower loads, namely in the low-pressure region. Practically, the inner shell is produced of one piece here, more preferably as formed sheet metal part. Particularly advantageous here is the use of a tailored blank for producing the inner shell or the use of a tailored tube for producing the inner shell. With these customised metal sheets or tubes regions of different wall thicknesses can be particularly easily realised, which then with appropriate forming create the inner shell with the regions of different wall thickness.

Further important features and advantages of the invention are obtained from the subclaims, from the drawings and from the corresponding figure description by means of the drawings.

It is to be understood that the features mentioned above and still to be explained in the following cannot only be used in the respective combinations stated but also in other combinations or by themselves without leaving the scope of the present invention.

Preferred exemplary embodiments of the invention are shown in the drawings and are explained in more detail in the following description, wherein same reference characters relate to same or similar or functionally same components.

It shows, in each case schematically,

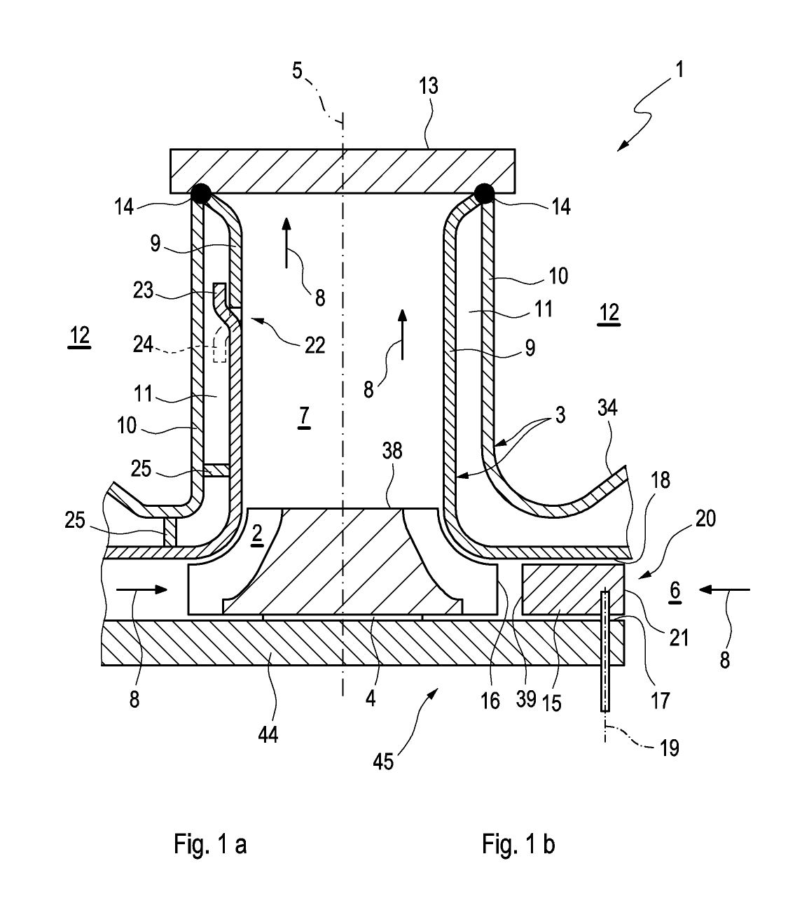

FIGS. 1 to 4 each a greatly simplified sectional view of an exhaust gas turbocharger in the region of a turbine housing in each case with two embodiments a and b,

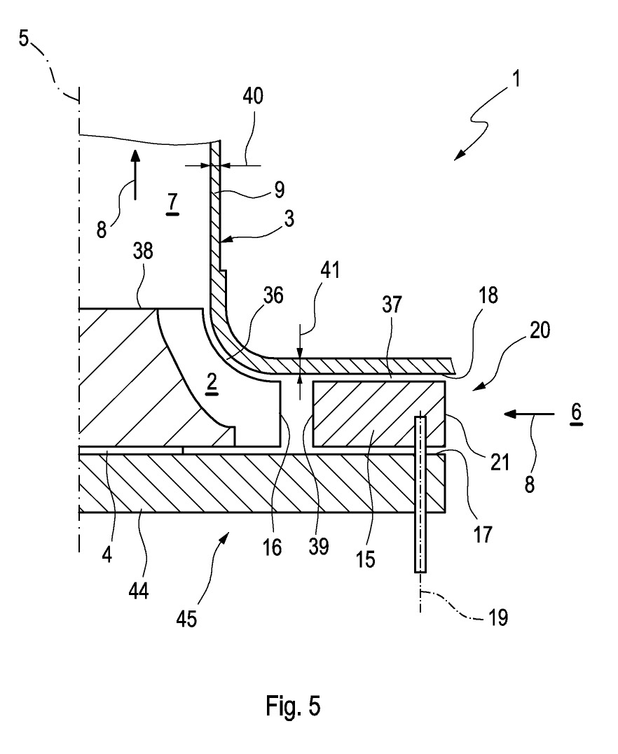

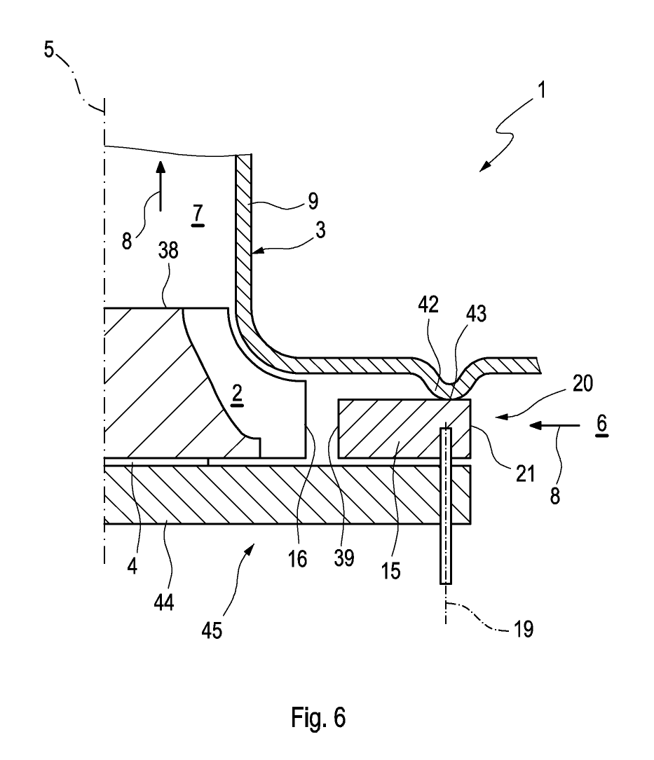

FIGS. 5 and 6 further embodiments in longitudinal section as in FIGS. 1 to 4,

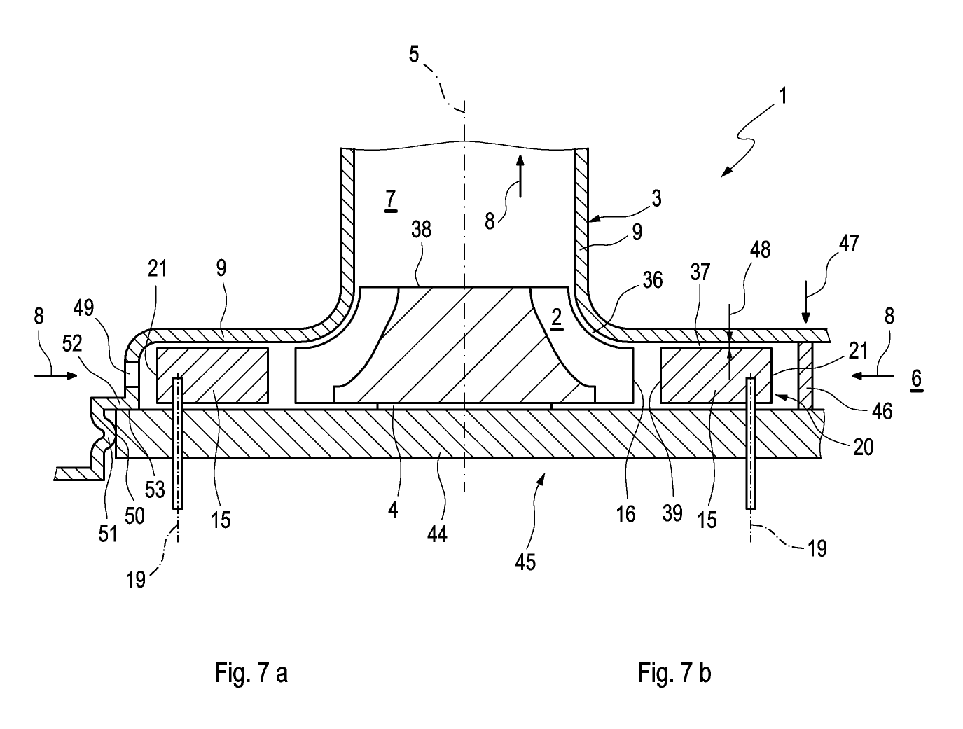

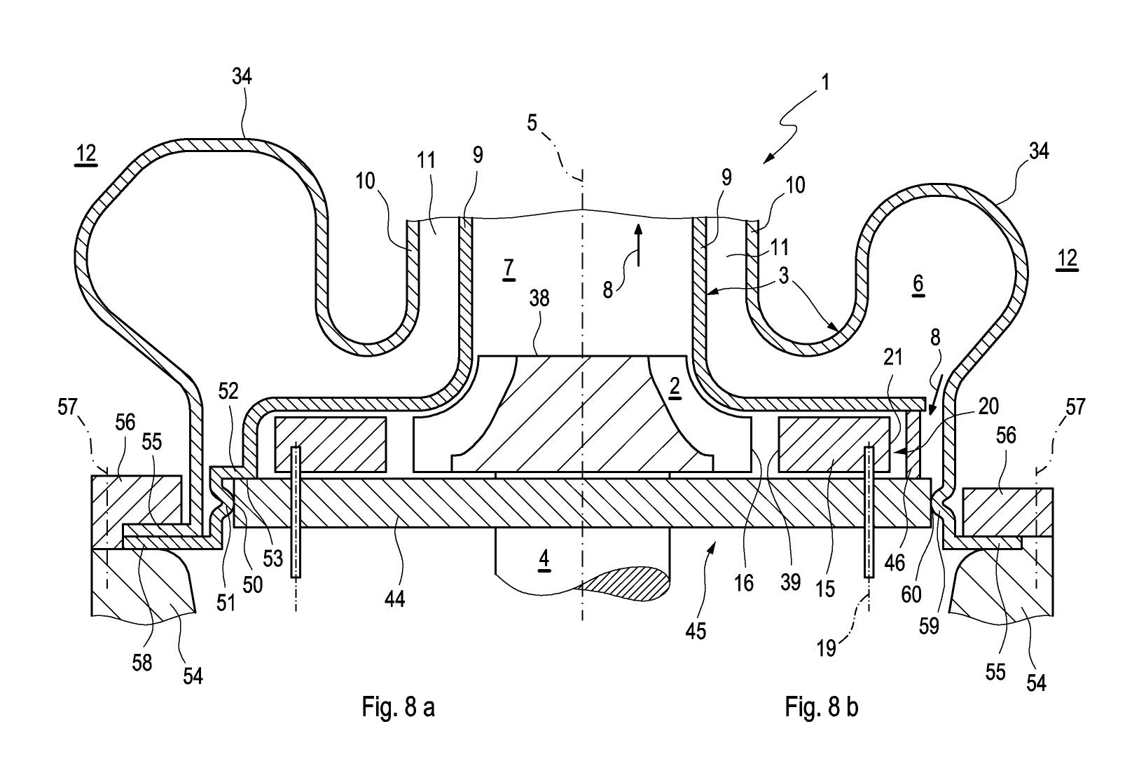

FIGS. 7 and 8 again views as in the FIGS. 1 to 4, however with other embodiments, in each case with two embodiments a and b.

According to the FIGS. 1 to 8 an exhaust gas turbocharger 1 only shown partially comprises a turbine wheel 2 and a turbine housing 3. The exhaust gas turbocharger 1 or briefly turbocharger 1 serves for charging fresh air of a combustion engine, which more preferably can be located in a road vehicle. To this end, it comprises in the usual manner a compressor wheel—which is not shown—which is connected to the turbine wheel 2 via a common driveshaft 4. The turbine wheel 2 serves for expanding exhaust gas of the combustion engine and is rotatably mounted about an axis of rotation 5. The axis of rotation 5 simultaneously forms an axis of symmetry or lies in a separating plane which within the same representation separates a left embodiment (a) from a right embodiment (b).

In the turbine housing 3 the turbine wheel 2 is arranged, namely between a high-pressure region 6 of the turbine housing 3 located upstream of the turbine wheel 2 and a low-pressure region 7 of the turbine housing 3 located downstream of the turbine wheel 2. The exhaust flow direction in the turbine housing 3 is indicated by arrows 8.

The turbine housing 3 in the low-pressure region 7 is of a double-walled design in order to realise an air gap insulation. To this end, the turbine housing 3 in the low pressure region 7 is equipped with an inner shell 9 and with an outer shell 10. The inner shell 9 conducts the exhaust gas while the outer shell 10 envelopes the inner shell 9 such that between the shells 9, 10 an insulation gap 11 is obtained. In other words, the two shells 9, 10 are arranged for forming an air gap insulation. Because of this, the radiation of heat to the outside into surroundings 12 of the turbocharger 1 can be substantially reduced in the low-pressure region 7.

The turbine housing 3 practically has an outlet flange 13 with the help of which the exhaust gas turbocharger 1 can be connected to an exhaust system of the combustion engine which is not shown here. This outlet flange 13 forms a separate component with respect to the inner shell 9 and the outer shell 10 and is connected to the two shells 9, 10 in a suitable manner. According to FIGS. 1 to 4 a material connection 14 which connects the inner shell 9 and the outer shell 10 to the outlet flange 13 is preferred here. Such a material connection 14 is preferably a welded connection, and namely in particular a closed circumferential weld seam. Alternatively, a soldered connection is also conceivable in principle.

With the preferred embodiment shown here the material connection 14 is designed so that the inner shell 9 and the outer shell 10 are also materially connected to each other in the process, namely directly to the outlet flange 13. Thus only one single material connection is required in order to fasten the two shells 9, 10 to each other and to the outlet flange 13.

The inner shell 9 preferably is a formed sheet metal part, as a result of which the inner shell 9 can be produced comparatively economically and with a high surface quality through forming. The outer shell 10 can also be a formed sheet metal part in principle. Alternatively, a conception as casting is also possible for realising the outer shell 10.

As is evident from FIGS. 1 to 8 it can be provided according to preferred embodiments to arrange guide vanes 15 in the high-pressure regions 6, wherein these guide vanes 15 are arranged distributed along an inlet 16 of the turbine wheel 2 in circumferential direction. The guide vanes 15 are arranged between two walls 17 and 18 opposing each other, which walls conduct the exhaust gas. The guide vanes 15 can be fixed in principle. However, adjustable guide vanes 15 each of which can be rotated about an own swivel axis 19 are preferred in order to vary the deflection angle or the onflow of the turbine wheel 2. At the same time, the cross section of the turbine housing 3 through which the flow can flow and which is present in the region of the guide vanes 15 can be changed in the high-pressure region 6. Through the adjustable guide vanes 15 a variable turbine geometry 20 is realised with the help of which dependent on the operating state of the combustion engine the inflow to the turbine wheel 2 and thus the power of the turbocharger 1 can be adjusted.

According to FIGS. 1 to 8 the inner shell 9 according to a preferred embodiment can extend as far as to the guide vanes 15, namely as far as to an inlet 21 of the guide vanes 15 so that the inner shell 9 forms the wall 18 of the two walls 17, 18 conducting exhaust gas.

According to FIG. 1a the inner shell 9 can have at least one sliding seat 22 in which two inner shell portions 23, 24 are axially adjustable relative to each other, that is parallel to the axis of rotation 5. As a result of this, in particular thermally related expansion effects can be compensated. This can be necessary since the inner shell 9 during operation of the turbocharger 1 is heated more quickly than the outer shell 10 and can also reach a higher end temperature. The one inner shell portion 23 is connected in a fixed manner to the outer shell 10 upstream of the sliding seat 22. Here, corresponding connecting points are designated 25. The connection of this inner shell portion 23 on the on flow side to the outer shell 10 can for example be realised via web-like connecting points 25, wherein corresponding connecting webs can be materially connected to the inner shell portion 23 on the on flow side and to the outer shell 10. The other inner shell portion 24 is connected to the outer shell 10 and/or to the outlet flange 13 downstream of the sliding seat 22, namely more preferably through the material connection 14. Accordingly, this is an inner shell portion 24 on the outflow side.

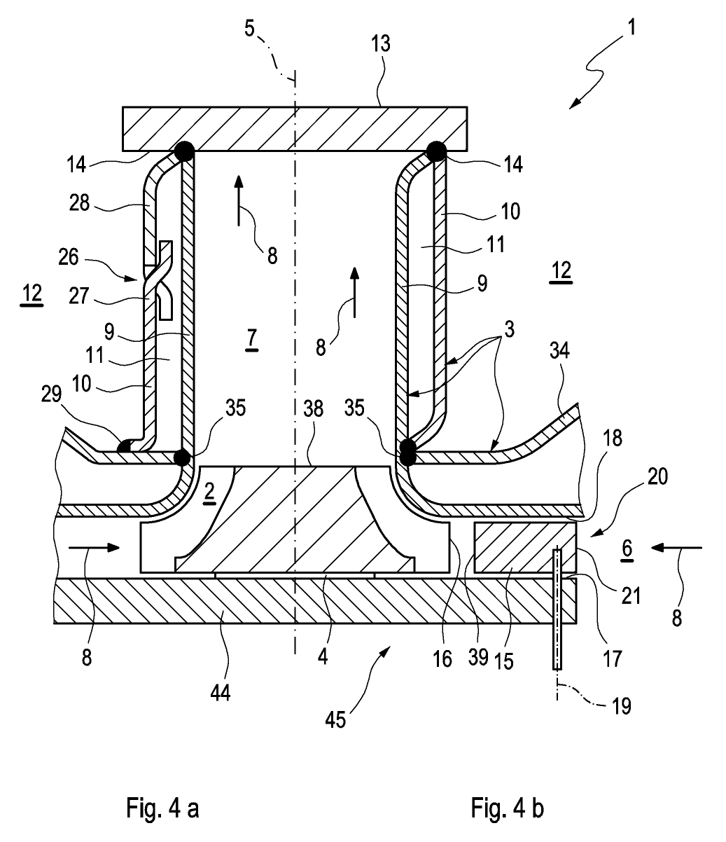

Similar can also be realised for the outer shell 10. Accordingly, FIG. 4a exemplarily shows an embodiment wherein the outer shell 10 is equipped with a sliding seat 26, in which an outer shell portion 27 on the onflow side connected in a fixed manner to the remaining turbine housing 3 upstream of this sliding seat 26 is adjustable relative to an outer shell portion 28 on the outflow side connected in a fixed manner to the inner shell 9 and/or to the outlet flange 13 downstream of the sliding seat 26. A connecting point between the outer shell portion 27 on the onflow side and the remaining turbine housing 3 is designated 29 in this case. This, too, preferably is a weld seam.

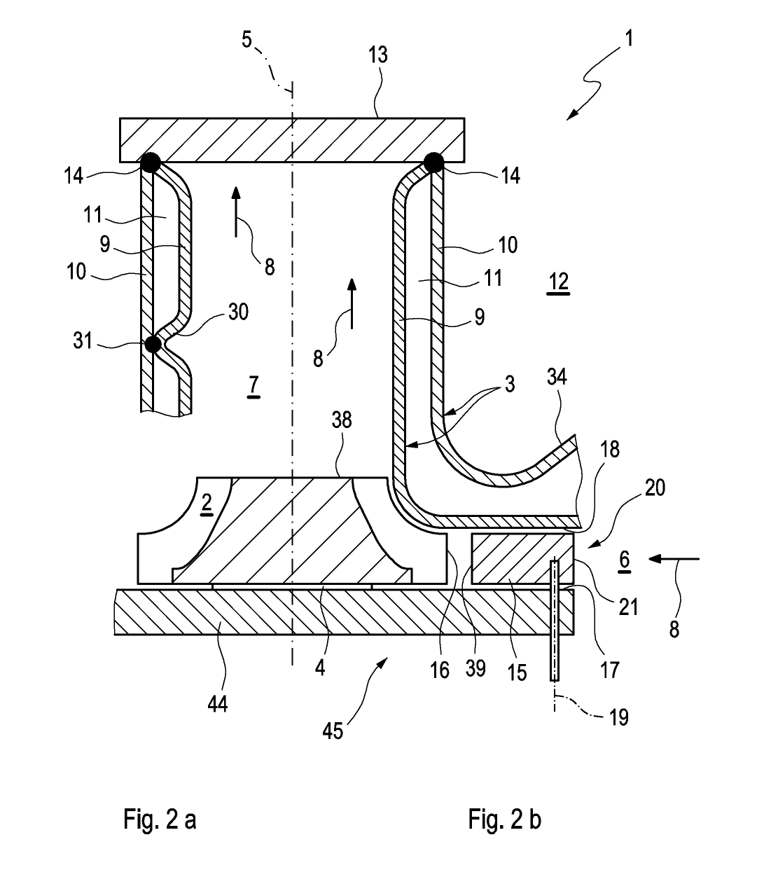

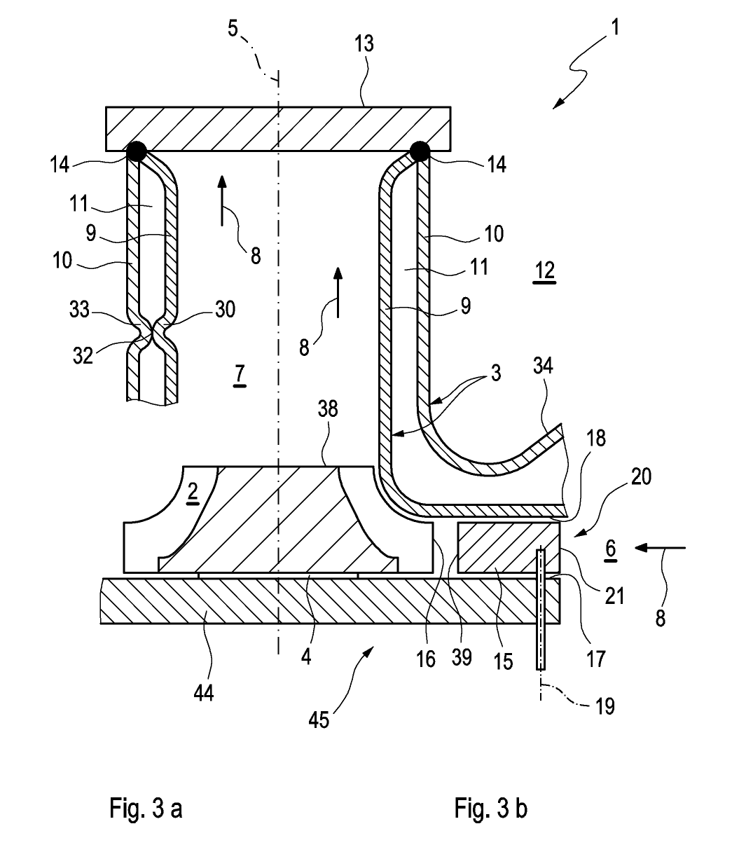

According to FIGS. 2a and 3a the inner shell 9 in the low-pressure region 7 can comprise at least one bead 30 which is provided in such a manner that it protrudes towards the outer shell 10. There, this bead 30 protrudes over the inner shell 9 so far that it supports the inner shell 9 on the outer shell 10. Thereby, it is possible in principle that the inner shell 9 according to FIG. 2a is materially connected to the outer shell 10 in the region of the respective bead 30. A corresponding material connection is designated 31 in FIG. 2a. As an alternative to this it is likewise possible to realise the support of the inner shell 9 via the respective bead 30 on the outer shell 10 according to FIG. 3a such that the inner shell 9 in the region of the respective bead 30 loosely comes to bear against the outer shell 10. As a result of this, a sliding seat is again realised which in FIG. 3a is designated 32. Independently of whether in the region of the bead 30 on the inner shell side a sliding seat 32 or a material connection 31 to the outer shell 10 is realised, the outer shell 10 according to FIG. 3a can itself also have a bead 33 in the region of the respective bead 30 of the inner shell 9 which protrudes towards the inner shell 9 namely in such a manner that ultimately the bead 30 of the inner shell 9 supports itself on the bead 33 of the outer shell 10.

The respective beads 30 and 33 can be configured in a dot-shaped manner or wart-shaped, wherein then several such beads 30, 33 are arranged in a distributed manner spaced from one another with respect to the axis of rotation 5 in circumferential direction. Alternatively it is likewise possible to configure the respective bead 30 and 33 in the shape of a ring.

According to FIGS. 1 to 4 and 8 the turbine housing 3 can preferentially comprise a volute 34. This is a type of spiral-shaped housing with a cross section through which a flow can flow that diminishes in flow direction, as a result of which this housing looks like a snail's house. The shaping serves to realise an even onflow of the turbine wheel 2. Accordingly, the volute 34 is located in the high-pressure region 6 of the turbine housing 3. With respect to the inner shell 9 it forms a separate component. According to FIGS. 1 to 3 and 8 the volute 34 can form an integral component together with the outer shell 10 so that the outer shell 10 is integrally moulded out of the volute 34. Alternatively it is likewise possible according to FIG. 4 to embody the outer shell 10 with respect to the volute 34 as a separate component which is then connected to the volute 34 in a suitable manner. More preferably the outer shell 10 according to FIG. 4a can be materially connected to the volute 34 via the connecting point 29 or according to FIG. 4b, via a connecting point 35.

Here, the volute 34 can be a formed sheet metal part or a casting.

The inner shell 9 according to FIGS. 1 to 3 and 8 can be positioned in the turbine housing 3 largely independently of the volute 34 so that more preferably no direct contact between inner shell 9 and volute 34 occurs. As an alternative to this, FIGS. 4a and 4b show embodiments wherein the inner shell 9 in each case is materially connected to the volute 34. There, a corresponding connecting point is designated 35. According to FIG. 4b, this connecting point can practically coincide with the connecting point via which the outer shell 10 is also connected to the volute 34 and thus ultimately also to the inner shell 9.

With the embodiments shown here, the inner shell 9 extends as far as to the inlet 16 of the turbine wheel 2. The inner shell 9 likewise extends over and beyond the inlet 16 of the turbine wheel 2 as far as to an inlet 21 of the guide vanes 15. Here, an embodiment wherein the inner shell 9 defines a turbine wheel contour gap 36 and optionally a guide vane contour gap 37 in addition is particularly practical. The turbine wheel contour gap 36 extends between the turbine wheel 2 and the inner shell 9 from the inlet 16 of the turbine wheel 2 as far as to an outlet 38 of the turbine wheel 2. In contrast with this, the guide vane contour gap 37 extends between the guide vanes 15 and the inner shell 9 from the inlet 21 of the guide vanes 15 as far as to an outlet 39 of the guide vanes 15. Through the specific shaping of the inner shell 9 high-quality contour gaps 36, 37 can be realised which are particularly characterized by comparatively small dimensions and consequently by reduced leakages or bypass flows.

Particularly advantageous now is an embodiment wherein the inner shell 9 and the turbine wheel 2 are produced of materials having similar or same heat expansion coefficients. Insofar as guide vanes 15 are present, the guide vanes 15 can preferentially also be produced of a material having a similar or same heat expansion coefficient as the materials of the inner shell 9 and the turbine wheel 2. Same heat expansion coefficients in the present context should be present when in the relevant temperature range the individual heat expansion coefficients differ from one another by a maximum of 1%. Similar heat expansion coefficients in the present context should be present when in the relevant temperature range the individual heat expansion coefficients differ from one another by a maximum of 10%. Similar or same heat expansion coefficients for the turbine wheel 2 and the inner shell 9 as well as for the guide vanes 15 if applicable result in that in the relevant temperature range the respective contour gap 36 does not or not substantially change due to thermal expansion effects.

With the special embodiment shown in FIG. 5 the inner shell 9, which extends from the low-pressure region 7 as far as to the inlet 16 of the turbine wheel 2 or to the inlet 21 of the guide vanes 15, has a wall thickness 40 downstream of the turbine wheel 2 which is smaller than a wall thickness 41 which the inner shell 9 has in the region of the turbine wheel 2 or in the region of the guide vanes 15. This can be an advantage for the dimensional stability of the contour gap 36, 37 throughout the temperature range of the turbocharger 1. This is preferably realised with an integrally produced inner shell 9, so that the regions with different wall thicknesses 40, 41 are integrally moulded on each other. To realise such an inner shell 9 a so-called tailored blank or a so-called tailored tube can be used for example. A tailored blank is a sheet metal blank having at least two zones consisting of different metal sheets which are welded together at a joint. The same applies to a tailored tube wherein different pipe pieces are butt-welded together. As a result of this, blanks are provided which can then be used for the forming process to produce the inner shell 9.

With the embodiment shown in FIG. 6 the inner shell 9 again extends as far as to the inlet 21 of the guide vanes 15. As is evident, the inner shell 9 with this embodiment comprises at least one bead 42 in the region of the guide vanes 15, which protrudes in the direction of the guide vanes 15. There, the respective bead 42 protrudes to a single guide vane 15 or simultaneously to several guide vanes 15. There, the respective bead 42 can be dimensioned so that the inner shell 9 directly supports itself on the respective guide vane 15 via the respective bead 42. Depending on the geometry of the bead 42 a contact point 43 between inner shell 9 and guide vane 15 can be configured in a dot-shaped manner. A linear contact is likewise possible. Contact over an area is likewise possible. Provided that a variable turbine geometry 20 is used, the inner shell 9 supports itself on the respective guide vane 15 via the respective bead 42 preferably in the region of the swivel axis 19. There, a support in a dot-shaped manner is preferred, wherein the swivel axis 19 practically runs through the dot-shaped contact point 43.

The guide vanes 15 are practically attached to a guide vane carrier 44 which with respect to the turbine housing 3 is a separate component and more preferably together with the guide vanes 15 forms a pre-assemblable unit 45 which can also be designated cartridge 45. The guide vane carrier 44 according to FIG. 7b and FIG. 8b can comprise several spacer elements 46 on which the inner shell 9 in the region of the guide vanes 15 or in the high-pressure region 6 is supported. There, the inner shell 9 practically rests loosely on the spacer elements 46 so that the inner shell 9 is moveable relative to the spacer elements 46 transversely to the support direction, which in FIG. 7b is indicated by an arrow 47. Insofar, a floating mounting on the guide vane carrier 44 is obtained for the inner shell 9. The spacer elements 46 with a variable turbine geometry 20 parallel to the swivel axis 19, which practically extends parallel to the axis of rotation 5, are longer than the guide vanes 15, as a result of which a gap width 48 of the guide vane contour gap 37 is defined.

According to FIGS. 7a and 8a the inner shell 9 can extend over the inlet 21 of the guide vanes 15 and beyond as far as to the guide vane carrier 44 in such a manner that the inner shell 9 traverses the high-pressure region 6 of the turbine housing 3. However, in order to still make possible inflow to the guide vanes 15 or to the turbine wheel 2 the inner shell 9 has inflow openings 49 at the inlet 21 of the guide vanes 15 through these inflow openings 49. The exhaust gas flows to the guide vanes 15 through these inflow openings 49. With this embodiment the guide vane carrier 44 with respect to the axis of rotation 5 can be positioned radially through the inner shell 9. To this end, the inner shell 9 at 50 radially touches the guide vane carrier 44. To this end, the inner shell 9 in the region of this contact point 50 can comprise a bead 51 which in the direction of the guide vane carrier 44 radially stands away from the inner shell 9. In addition, the inner shell 9 can comprise a step 52 which makes possible axial positioning of the guide vane carrier 44 on the inner shell 9. A corresponding axial contact point is designated 53 in this case, in which the inner shell 9 axially comes to bear against the guide vane carrier 44.

According to FIGS. 8a and 8b the turbocharger 1 can additionally comprise a bearing housing 54 which is only shown partially, in which the driveshaft 4 is rotatably mounted about the axis of rotation 5. The guide vane carrier 44 with respect to the axis of rotation 5 is arranged axially between this bearing housing 54 and the turbine wheel 2. On the bearing housing 52 the outer shell 10 or—depending on embodiment—the volute 34 is fastened. For this purpose, an end 55 of the volute 34 is fixed more preferably screwed to the bearing housing 54 by means of a fastening ring 56. Corresponding screwing points are indicated in FIGS. 8a and 8b by dash-dotted lines and designated 57.

With the embodiment shown in FIG. 8a the inner shell 9 analog to FIG. 7a again extends through the high-pressure path and beyond as far as to the guide vane carrier 44 and additionally with an end portion 58 as far as into the fastening region, so that with the help of the fastening ring 56 the inner shell 9 can be simultaneously fastened to the bearing housing 54 as well. Radial positioning of the guide vane carrier 44 in this case is effected via the inner shell 9, more preferably in conjunction with the at least one bead 51.

In contrast with this, FIG. 8b shows an embodiment according to FIG. 7b wherein the inner shell 9 ends in the region of the guide vane carrier 44, i.e. ends within the high-pressure region 6. The radial positioning of the guide vane carrier 44 in this case is effected via the volute 34 or via the outer shell 10. There, the outer shell 10 or the volute 34 can comprise at least one bead 59 which via at least one radial contact point 60 brings about radial positioning of the guide vane carrier 44. To this end, the outer shell 10 or the volute 34 is axially run past the guide vane carrier 44 in such a manner that the outer shell 10 or the volute 34 encloses the guide vane carrier 44 with respect to the axis of rotation 5.

1. An exhaust gas turbocharger, comprising: a turbine wheel rotatably mounted about an axis of rotation, wherein the turbine wheel expands a combustion engine exhaust gas; and
a turbine housing, wherein the turbine housing includes a high-pressure region and a low-pressure region, the turbine wheel is arranged between the high-pressure region and the low-pressure region, and wherein the low-pressure region has an inner shell conducting the exhaust gas and an outer shell, which is arranged for forming an air gap insulation.

2. The exhaust gas turbocharger according to claim 1, wherein the turbine housing comprises an outlet flange for connecting the exhaust gas turbocharger to an exhaust system of the combustion engine, which with regard to the inner shell and the outer shell is a separate component, wherein the inner shell and the outer shell are connected to the outlet flange, and to each other on the outlet flange.

3. The exhaust gas turbocharger according to claim 1, wherein at least one of the inner shell and the outer shell are formed of at least one of sheet metal and a casting.

4. The exhaust gas turbocharger according to claim 1, wherein at least one guide vane is arranged in the high-pressure region between two walls located opposite each other and conducting the exhaust gas, and wherein the inner shell extends to the guide vanes and forms one of the walls conducting the exhaust gas.

5. The exhaust gas turbocharger according to claim 1, wherein the inner shell has a sliding seat, wherein on the onflow side an inner shell portion is fixedly connected to the outer shell upstream of the sliding seat, and wherein the sliding seat is adjustable relative to an inner shell portion on the outflow side and is fixedly connected to at least one of the outer shell and the outlet flange downstream of the sliding seat.

6. The exhaust gas turbocharger according to claim 1, wherein the inner shell comprises at least one bead which protrudes towards the outer shell so that the inner shell supports itself on the outer shell in the region of the bead, wherein the inner shell is connected to the outer shell in the region of the bead, and wherein the outer shell includes at least one additional bead, which protrudes towards the inner shell so that the bead of the inner shell supports itself on the additional bead of the outer shell.

7. The exhaust gas turbocharger according claim 1, wherein the turbine housing in the high-pressure region comprises a volute which with respect to the inner shell is a separate component, wherein the inner shell is connected to the volute and the outer shell is connected to at least one of the volute, the inner shell and the volute, and is integrally moulded out of the volute.

8. The exhaust gas turbocharger according to claim 1, wherein the inner shell extends to an inlet of the turbine wheel and defines a turbine wheel contour gap, which extends between the turbine wheel and the inner shell from the inlet of the turbine wheel to the outlet of the turbine wheel, and wherein the inner shell extends to an inlet of guide vanes arranged upstream of the turbine wheel and defines a guide vane contour gap, which extends between the guide vanes and the inner shell from the inlet of the guide vanes to the outlet of the guide vanes wherein at least one of the inner shell and the turbine wheel; and the inner shell, the turbine wheel and the guide vanes are produced of materials having at least one of similar and same heat expansion coefficients.

9. The exhaust gas turbocharger according to claim 1, wherein the inner shell extends to at least one of an inlet of the turbine wheel and an inlet of guide vanes arranged upstream of the turbine wheel, and wherein the inner shell downstream of the turbine wheel has a smaller wall thickness than in at least one of the region of the turbine wheel, and the region of the turbine wheel and the guide vanes.

10. The exhaust gas turbocharger according to claim 1, wherein the inner shell extends to the inlet of guide vanes arranged upstream of the turbine wheel, wherein the inner shell in the region of the guide vanes comprises at least one bead which protrudes to at least one guide vane, wherein the respective bead supports itself on the respective at least one guide vane in a dot-shaped manner, wherein the guide vanes for a variable turbine geometry are each adjustable about a swivel axis, wherein the respective bead in the region of the swivel axis supports itself on the respective guide vane in a dot-shaped manner.

11. The exhaust gas turbocharger according to claim 1, wherein guide vanes are arranged upstream of the turbine wheel, wherein the inner shell extends to an inlet of the guide vanes, wherein the guide vanes are attached to a guide vane carrier having several spacer elements, on which the inner shell in the region of the guide vanes is supported and moveable relative to the spacer elements transversely to the support direction, wherein the guide vanes for a variable turbine geometry are each adjustably arranged about a swivel axis on the guide vane carrier, and wherein the respective spacer element parallel to the swivel axes is longer than the guide vanes.

12. The exhaust gas turbocharger according to claim 1, wherein guide vanes are arranged and attached to a guide vane carrier upstream of the turbine wheel, wherein the inner shell extends over and beyond the inlet of the guide vanes to the guide vane carrier and at the inlet of the guide vanes, the guide vane carrier includes inflow openings through which the exhaust gas reaches the guide vanes, and wherein the guide vane carrier is positioned radially through the inner shell with respect to the axis of rotation.

13. The exhaust gas turbocharger according to claim 1, wherein a guide vane carrier carries several guide vanes arranged upstream of the turbine wheel and with respect to the axis of rotation is arranged axially between the turbine wheel and a bearing housing in which a driveshaft comprising the turbine wheel is rotatably mounted about the axis of rotation, wherein at least one of the outer shell and a volute of the turbine housing is fastened to the bearing housing, wherein at least one of the outer shell and the volute encloses the guide vane carrier with respect to the axis of rotation, wherein at least one of the outer shell and the volute radially positions the guide vane carrier with respect to the axis of rotation, by at least one of at least one bead protruding to the guide vane carrier and in that the inner shell extends to the bearing housing where it is fastened to the bearing housing together with at least one of the outer shell and with the volute, encloses the guide vane carrier with respect to the axis of rotation and radially positions said guide vane carrier by at least one bead protruding to the guide vane carrier.

14. The exhaust gas turbocharger according to claim 2, wherein at least one of the inner shell and the outer shell are formed of at least one of sheet metal and casting.

15. The exhaust gas turbocharger according to claim 2, wherein at least one guide vane is arranged in the high-pressure region between two walls located opposite each other and conducting the exhaust gas, and wherein the inner shell extends to the guide vanes and forms one of the walls conducting the exhaust gas.

16. The exhaust gas turbocharger according to claim 2, wherein the inner shell has a sliding seat, wherein on the onflow side an inner shell portion is fixedly connected to the outer shell upstream of the sliding seat, and wherein the sliding seat is adjustable relative to an inner shell portion on the outflow side and is fixedly connected to at least one of the outer shell and the outlet flange downstream of the sliding seat.

17. The exhaust gas turbocharger according to claim 2, wherein the inner shell comprises at least one bead which protrudes towards the outer shell so that the inner shell supports itself on the outer shell in the region of the bead, wherein the inner shell is materially connected to the outer shell in the region of the bead, and wherein the outer shell includes at least one additional bead, which protrudes towards the inner shell so that the bead of the inner shell supports itself on the additional bead of the outer shell.

18. The exhaust gas turbocharger according claim 2, wherein the turbine housing in the high-pressure region comprises a volute which with respect to the inner shell is a separate component, wherein the inner shell is materially connected to the volute and the outer shell is likewise materially connected to at least one of the volute, the inner shell and the volute, and is integrally moulded out of the volute.

19. The exhaust gas turbocharger according to claim 2, wherein the inner shell extends to an inlet of the turbine wheel and defines a turbine wheel contour gap which extends between the turbine wheel and the inner shell from the inlet of the turbine wheel to the outlet of the turbine wheel, and wherein the inner shell extends to an inlet of guide vanes arranged upstream of the turbine wheel and defines a guide vane contour gap which extends between the guide vanes and the inner shell from the inlet of the guide vanes to the outlet of the guide vanes wherein at least one of the inner shell and the turbine wheel; and the inner shell, the turbine wheel and the guide vanes are produced of materials having at least one of similar and same heat expansion coefficients.

20. The exhaust gas turbocharger according to claim 2, wherein the inner shell extends to at least one of an inlet of the turbine wheel and an inlet of guide vanes arranged upstream of the turbine wheel, and wherein the inner shell downstream of the turbine wheel has a smaller wall thickness than in at least one of the region of the turbine wheel, the region of the turbine wheel and the guide vanes.
